(19) United States
(12) Patent Application Publication
(10) Pub. No.: US 2019/0011687 A1
(43) Pub. Date: Jan. 10, 2019

(54) IMAGE MEASUREMENT APPARATUS

(71) Applicant: Mitutoyo Corporation, Kawasaki-shi (JP)

(72) Inventors: Norihiko Masuda, Kawasaki-shi (JP); Yuki Nakajima, Kawasaki-shi (JP)

(21) Appl. No.: 16/012,083

(22) Filed: Jun. 19, 2018

(30) Foreign Application Priority Data
Jul. 4, 2017 (JP) 2017-130974

(51) Int. Cl. G02B 21/26; G02B 21/00; G06T 7/70; G06T 7/00

(52) U.S. Cl. CPC G02B 21/26; G02B 21/0084; G02B 21/0052; G06T 7/0002; G06T 7/70

(57) ABSTRACT

An image measurement apparatus includes an image pickup unit, a mounting unit, and a judgment unit. The image pickup unit captures a measurement target. The measurement target is mounted on the mounting unit, the mounting unit being capable of moving relative to the image pickup unit. The judgment unit judges, based on information related to a relative position between the image pickup unit and the mounting unit within a predetermined time, whether capturing of a measurement image by the image pickup unit is possible.

### CROSS REFERENCE TO RELATED APPLICATIONS

This application claims the benefit of Japanese Priority Patent Application JP 2017-130974 filed Jul. 4, 2017, the entire contents of which are incorporated herein by reference.

### BACKGROUND

The present invention relates to an image measurement apparatus.

From the past, a technology of capturing a measurement target while moving an image pickup range has been known. For example, Japanese Patent Application Laid-open No. 2013-171425 (hereinafter, referred to as Patent Literature 1) describes an image processing apparatus for generating a synthetic image of a work by moving a stage. In Patent Literature 1, a stage on which a work is placed is appropriately moved in an X-axis direction and a Y-axis direction, and the work is captured at respective movement positions. The captured images of the work are synthesized by image matching processing to thus generate a synthetic image of the work. As a result, it becomes possible to generate an image of the work in a wider range than a one-shot image pickup range (paragraphs [0010], [0017], and [0020] in specification, FIG. 5, etc. of Patent Literature 1).

Further, Japanese Patent Application Laid-open No. Hei 10-31165 (hereinafter, referred to as Patent Literature 2) describes a scan-type laser microscope that detects vibrations of a stage on which a sample is placed in a Z direction. In Patent Literature 2, a relative distance between the stage and an objective lens is measured by a laser length measurement device, and the vibrations in the Z direction are detected. By monitoring the vibrations of the stage in the Z direction, image data having no image blur is generated (see paragraphs [0014], [0024], and [0028] in specification, FIG. 1, etc. of Patent Literature 2).

### SUMMARY

In capturing a measurement target while moving an image pickup range, it is important to avoid an influence of vibrations of a stage, and the like. There is a demand for a technology capable of accurately capturing a measurement target while suppressing an influence of such vibrations and the like.

In view of the circumstances as described above, an object of the present invention is to provide an image measurement apparatus capable of accurately capturing a measurement target in an observation accompanied by a movement of an image pickup range.

To attain the object described above, an image measurement apparatus according to an embodiment of the present invention includes an image pickup unit, a mounting unit, and a judgment unit.

The image pickup unit captures a measurement target.

On the mounting unit, the measurement target is mounted, the mounting unit being capable of moving relative to the image pickup unit.

The judgment unit judges, based on information related to a relative position between the image pickup unit and the mounting unit within a predetermined time, whether capturing of a measurement image by the image pickup unit is possible.

In this image measurement apparatus, the image pickup unit and the mounting unit can be moved relative to each other, and the measurement target mounted on the mounting unit is captured by the image pickup unit. It is judged whether the capturing of the measurement image is possible based on the information related to the relative position between the image pickup unit and the mounting unit within the predetermined time. Accordingly, it becomes possible to accurately capture the measurement target in an observation accompanied by a movement of the image pickup range.

The judgment unit may judge that the capturing of the measurement image is possible in a case where a change of the relative position between the image pickup unit and the mounting unit within the predetermined time falls within a predetermined range.

Accordingly, it becomes possible to capture the measurement image in a state where a relative vibration between the image pickup unit and the mounting unit is sufficiently small. As a result, it becomes possible to accurately capture the measurement target.

The mounting unit may include a mounting surface on which the measurement target is to be mounted and may be movable relative to the image pickup unit along a first direction and a second direction that are mutually orthogonal and parallel to the mounting surface.

Accordingly, it becomes possible to planarly move the image pickup range along the mounting surface. As a result, for example, it becomes possible to easily generate a synthetic image of the measurement target, or the like.

The image measurement apparatus may further include a coordinate detection unit capable of detecting a first coordinate value that indicates the relative position between the image pickup unit and the mounting unit along the first direction and a second coordinate value that indicates the relative position between the image pickup unit and the mounting unit along the second direction.

By judging the state where the capturing is possible based on the first and second coordinate values, it becomes possible to capture the measurement target with sufficient accuracy in an observation accompanied by a movement of the image pickup range.

The judgment unit may judge that the capturing of the measurement image is possible in a case where the first coordinate values within the predetermined time fall within a first range and the second coordinate values within the predetermined time fall within a second range.

Accordingly, it becomes possible to capture the measurement image in a state where vibrations in the first and second directions are sufficiently small and highly-accurately capture the measurement target.

Each of the first range and the second range may be a range that is set while using an image pickup position for capturing the measurement image as a reference.

Accordingly, it becomes possible to perform a movement operation to the image pickup position, and the like with high accuracy. As a result, for example, it becomes possible to highly-accurately capture the measurement target at a desired image pickup position.

The first range and the second range may have mutually-equal sizes.

This makes it easy to perform calculations and the like for determining the state where capturing of the measurement image is possible. As a result, a time required for the observation can be shortened.

The judgment unit may acquire each of the first coordinate values and the second coordinate values at a predetermined sampling rate and judge that the capturing of the measurement image is possible in a case where all of the first coordinate values in a number corresponding to the predetermined time fall within the first range and all of the second coordinate values in a number corresponding to the predetermined time fall within the second range.

Accordingly, for example, it becomes possible to judge the vibrations in the first and second directions in real time. As a result, a time required for the observation can be sufficiently shortened.

The number corresponding to the predetermined time may be a number with which a value obtained by multiplying a value, which is obtained by subtracting 1 from the number, by the predetermined sampling rate becomes equal to or larger than the predetermined time.

Accordingly, it becomes possible to capture the measurement image in a state where the vibrations are sufficiently small, for example, and highly-accurately capture the measurement target.

The judgment unit may judge that the capturing of the measurement image is possible in a case where a difference between a maximum value and minimum value of the first coordinate values within the predetermined time is smaller than a first threshold value and a difference between a maximum value and minimum value of the second coordinate values within the predetermined time is smaller than a second threshold value.

Accordingly, it becomes possible to capture the measurement image in a state where the vibrations in the first and second directions are sufficiently small and highly-accurately capture the measurement target.

The first and the second threshold values may be equal to each other.

This makes it easy to perform calculations and the like for judging the state where capturing of the measurement image is possible. As a result, a time required for the observation can be shortened.

The judgment unit may permit the image pickup unit to capture the measurement image in a case where it is judged that the capturing of the measurement image is possible.

Accordingly, it becomes possible to prevent the measurement target from being captured in a state unsuited for capturing of the measurement image, and thus avoid re-shooting due to erroneous capturing, and the like.

The judgment unit may output a request signal for requesting the image pickup unit to capture the measurement image in a case where it is judged that the capturing of the measurement image is possible.

Accordingly, it becomes possible to capture the measurement image in a state where relative vibrations between the image pickup unit and the mounting unit are sufficiently small, for example, and maintain high image pickup accuracy.

The image measurement apparatus may further include a switch unit that controls an input of the request signal to the image pickup unit.

Accordingly, it becomes possible to control an image pickup timing by the image pickup unit, for example, and thus improve operability of the apparatus.

The switch unit may include an operation switch for executing the capturing of the measurement image by the image pickup unit and input the request signal output from the judgment unit to the image pickup unit in response to an operation made to the operation switch.

By using the operation switch, it becomes possible to capture the measurement image at a desired timing, and thus improve operability of the apparatus.

The image measurement apparatus may further include an operation mechanism for manually moving the mounting unit. In this case, the operation switch may be arranged in a vicinity of the operation mechanism.

Accordingly, it becomes possible to carry out the movement operation and image pickup operation at hand, and thus significantly improve usability of the apparatus.

The operation switch may include a lighting unit that varies a lighting state based on at least one of a distance between a current position as a current relative position between the image pickup unit and the mounting unit and an image pickup position for capturing the measurement image, and a judgment result obtained by the judgment unit.

Accordingly, it becomes possible to perform the movement operation, image pickup operation, and the like based on the lighting state of the lighting unit, for example, and exert high operability.

The image measurement apparatus may further include a notification unit that notifies a judgment result obtained by the judgment unit.

Accordingly, it becomes possible to perform the movement operation and image pickup operation based on the judgment result, for example, and exert high operability.

The notification unit may notify a completion of the capturing of the measurement image by the image pickup unit.

Accordingly, it becomes possible to perform an operation of moving the mounting unit after confirming that the capturing of the measurement image has been completed. As a result, re-shooting due to erroneous capturing, or the like is avoided, and reliability of the apparatus is improved.

The image pickup unit may be capable of capturing an observation image for observing the measurement target.

By using the observation image, for example, the operations of moving the measurement target, capturing the measurement image, and the like are facilitated, and operability of the apparatus can be improved.

The image measurement apparatus may further include a display unit capable of displaying the measurement image and the observation image, and a display control unit that controls image display by the display unit.

Accordingly, it becomes possible to capture the measurement image while viewing the observation image, for example, and sufficiently improve operability of the apparatus.

The display control unit may generate an auxiliary image that assists the capturing of the measurement image and display the observation image and the auxiliary image on the display unit.

For example, it becomes possible to move the image pickup range while using the auxiliary image as a reference. Accordingly, the measurement target can be observed with ease.

The auxiliary image may include a guide image that indicates at least one of an area where the measurement image can be captured and an image pickup position for capturing the measurement image.

For example, by moving the image pickup range in accordance with the guide image, capturing of the measurement image can be readily executed. Accordingly, a time required for the observation can be sufficiently shortened.

The judgment unit may monitor the information related to the relative position between the image pickup unit and the mounting unit.

Accordingly, it becomes possible to constantly judge a state where the measurement image can be captured properly. As a result, it becomes possible to sufficiently improve operability of the apparatus.

The image measurement apparatus may further include a calculation unit that calculates, based on a first image and a second image captured by the image pickup unit at mutually-different timings, a deviation amount between the first image and the second image. In this case, the judgment unit may judge whether the capturing of the measurement image is possible based on the calculated deviation amount.

It becomes possible to easily detect a change in the relative position between the image pickup unit and the mounting unit, for example, based on the image captured by the image pickup unit.

The judgment unit may judge that the capturing of the measurement image is possible in a case where the deviation amount calculated by the calculation unit is smaller than a predetermined threshold value continuously for a predetermined number of times.

Accordingly, it becomes possible to capture the measurement image in a state where the relative vibrations between the image pickup unit and the mounting unit are sufficiently small. As a result, it is possible to accurately capture the measurement target.

A program according to an embodiment of the present invention causes a computer system to execute the following steps.

A step of capturing, by an image pickup unit that captures a measurement target, the measurement target.

A step of judging, based on information related to a relative position between the image pickup unit and a mounting unit on which the measurement target is mounted, the mounting unit being movable relative to the image pickup unit, within a predetermined time, whether capturing of a measurement image by the image pickup unit is possible.

As described above, according to the present invention, it becomes possible to accurately capture a measurement target in an observation accompanied by a movement of an image pickup range. It should be noted that the effects described herein are not necessarily limited, and any of the effects described in the present disclosure may be obtained.

### BRIEF DESCRIPTION OF DRAWINGS

FIG. 1 is a schematic diagram showing an outer appearance of an image measurement apparatus according to a first embodiment of the present invention;

FIG. 2 is a block diagram showing a configuration example of the image measurement apparatus;

FIG. 3 is a block diagram showing a functional configuration example of a control unit;

FIG. 4 is a perspective view showing a configuration example of an operation switch;

FIG. 5 is a graph showing a temporal change of a scale value;

FIG. 6 is a diagram for explaining an example of capturing of a measurement image;

FIGS. 7A and 7B are schematic diagrams for explaining an example of an observation screen and the measurement image;

FIGS. 8A and 8B are diagrams for explaining an operation of a lighting unit of the operation switch;

FIG. 9 is a diagram for explaining a judgment method according to a second embodiment, the diagram being a graph that shows a temporal change of the scale value; and

FIGS. 10A and 10B are diagrams for explaining a judgment method according to a third embodiment, the diagrams being schematic diagrams showing an example of images of a work captured at mutually-different timings.

### DETAILED DESCRIPTION OF EMBODIMENTS

Hereinafter, embodiments of the present invention will be described with reference to the drawings.

### First Embodiment

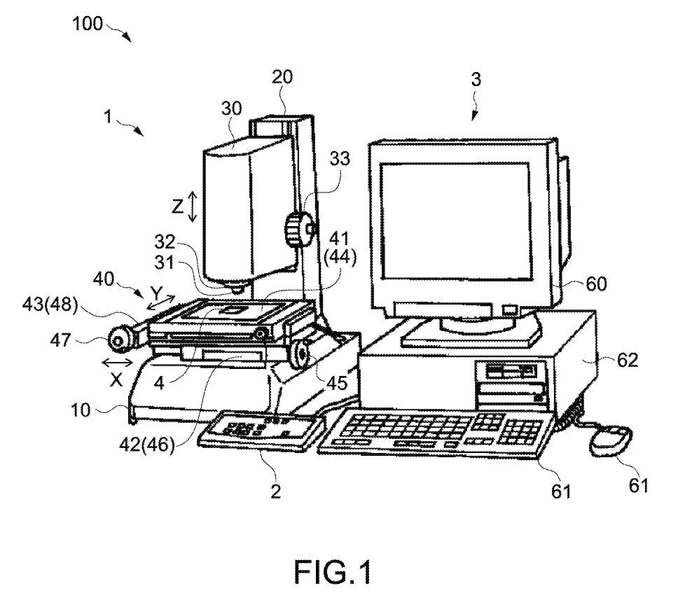

FIG. 1 is a schematic diagram showing an outer appearance of an image measurement apparatus according to a first embodiment of the present invention. As shown in FIG. 1, an image measurement apparatus 100 includes a measurement machine body 1, a command input unit 2, and a control system 3.

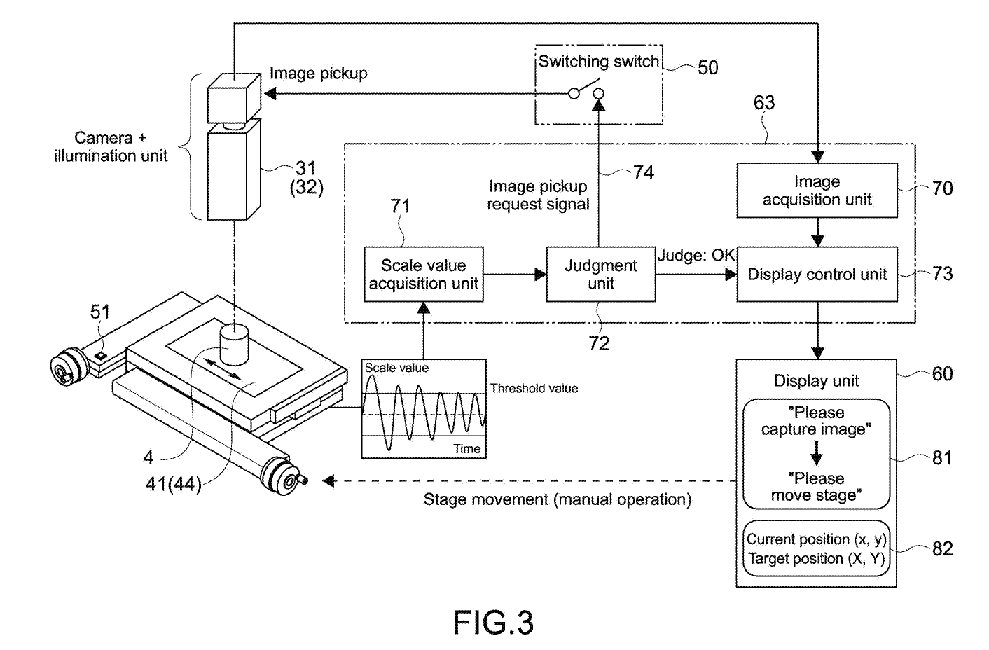

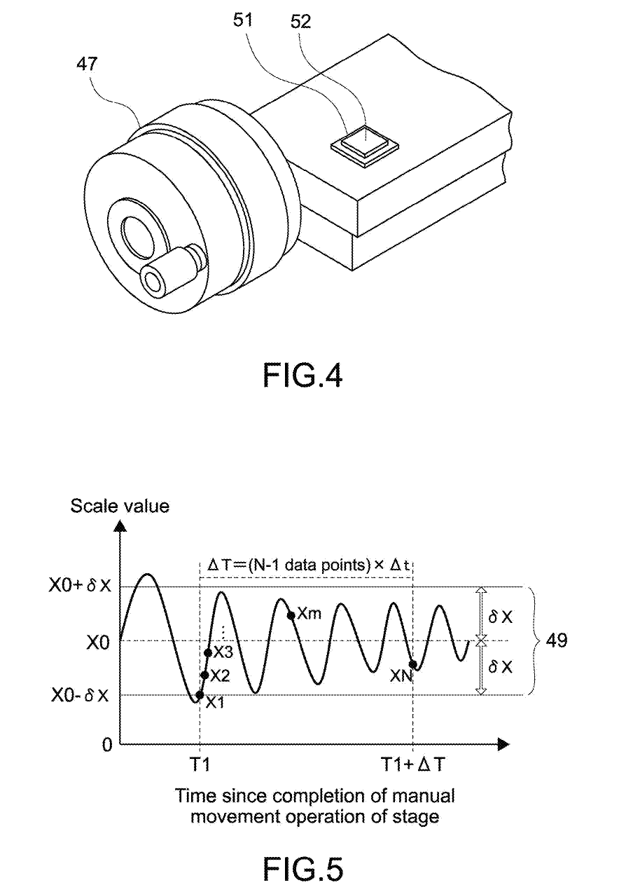

The measurement machine body 1 includes a mount 10, a frame 20, an image pickup unit 30, and a stage unit 40. The measurement machine body 1 also includes a switching switch 50 and an operation switch 51 (see FIGS. 3 and 4).

The mount 10 is placed on a desk, a workbench, or the like, and supports the frame 20 and the stage unit 40.

The frame 20 is arranged on one end side of the mount 10 and holds the image pickup unit 30 such that the image pickup unit 30 is movable in a longitudinal direction (Z-axis direction). The one end side where the frame 20 is arranged is set as a rear side of the measurement machine body 1, and a side opposite thereto is set as a front side. As shown in FIG. 1, the image pickup unit 30 is attached to the front side of the frame 20.

The image pickup unit 30 includes a camera 31, an illumination unit 32, and a Z-axis driving handle 33. As shown in FIG. 1, the image pickup unit 30 is arranged such that the camera 31 faces the stage unit 40.

The camera 31 captures an image of a work 4 as a measurement target. The camera 31 includes an optical system and an image sensor that captures an image of the measurement target imaged by the optical system (both of which are not shown). As the optical system, for example, a telecentric optical system having a large focal depth, or the like is used.

As the image sensor, for example, a CMOS (Complementary Metal-Oxide Semiconductor) sensor, a CCD (Charge Coupled Device) sensor, or the like is used. A specific configuration of the camera 31 is not limited. In this embodiment, the camera 31 corresponds to an image pickup unit that captures an image of the measurement target.

The camera 31 captures a measurement image for performing an image measurement of the work 4. The measurement image is captured based on predetermined image pickup parameters such as an exposure time, an image pickup sensitivity, and a resolution. Measurements of dimensions, angles, tilts, and the like of respective parts of the work 4 and an image measurement such as an inspection of a rough shape by an edge detection can be performed based on the captured measurement image. Further, a synthetic image of the work 4 and the like can be generated by synthesizing measurement images.

Furthermore, the camera 31 captures an observation image for observing the work 4. The observation image is an image that is acquired constantly, and is captured at a predetermined frame rate, for example. By using the observation image, it becomes possible to move the work 4 and capture a measurement image while observing the work 4 in real time, for example.

For example, the measurement image is captured at a timing desired by a user, and when the measurement image is not captured, an observation image is captured at a predetermined frame rate. Therefore, it can be said that the camera 31 captures an image of the measurement target while making a switch between a mode for capturing a measurement image and a mode for capturing an observation image.

The illumination unit 32 emits illumination light for capturing the work 4. Brightness of the illumination light is controlled by the control system 3, for example. As the illumination unit 32, a ring light that uses a light emitting device such as an LED (Light Emitting Diode) is used, for example.

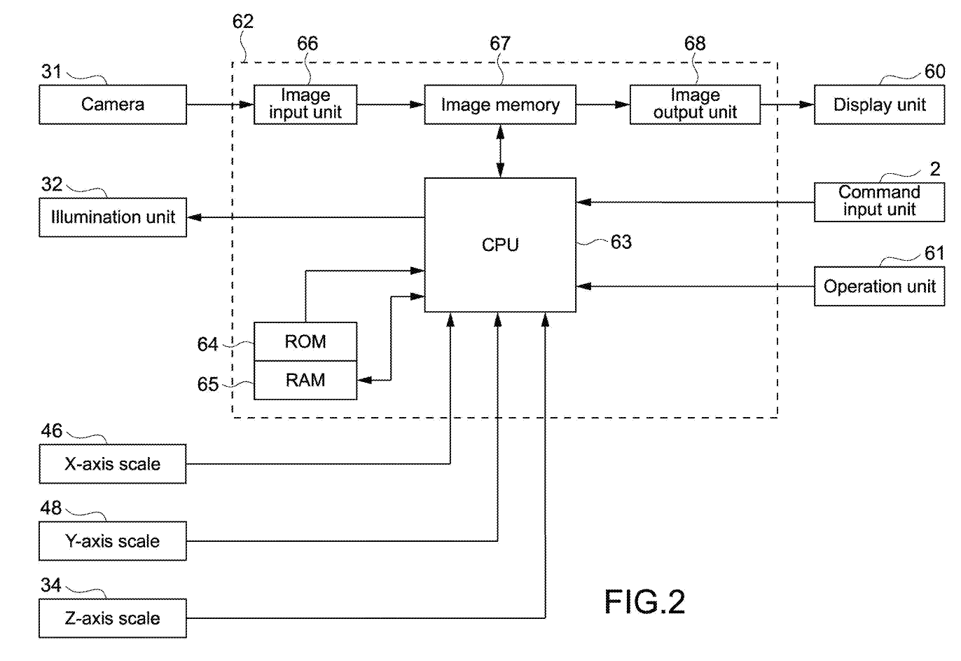

The Z-axis driving handle 33 is an operation mechanism for moving the image pickup unit 30 along a Z-axis direction. By operating the Z-axis driving handle 33, for example, a focal point of the camera 31 can be adjusted. It should be noted that a position of the image pickup unit 30 in the Z-axis direction is detected by a Z-axis scale 34 (see FIG. 2) (not shown).

The stage unit 40 includes a measurement table 41, an X-axis stage 42, and a Y-axis stage 43.

The measurement table 41 has a plate-like shape and includes a mounting surface 44. The work 4 as the measurement target is mounted on the mounting surface 44.

In this embodiment, the mounting surface 44 is configured to be orthogonal to the Z-axis direction. As the measurement table 41, for example, a glass plate or the like is used. A specific configuration of the measurement table 41 is not limited, and the measurement table 41 may be configured as appropriate according to, for example, a type, shape, and the like of the work 4. In this embodiment, the measurement table 41 corresponds to a mounting unit.

Hereinafter, directions that are parallel to the mounting surface 44 while being orthogonal to each other are defined as an X-axis direction and a Y-axis direction. In the example shown in FIG. 1, the X-axis direction is set in a lateral direction when the measurement machine body 1 is viewed from the front side, and the Y-axis direction is set in a front-back direction. In this embodiment, the X-axis direction corresponds to a first direction, and the Y-axis direction corresponds to a second direction.

The X-axis stage 42 is arranged on the mount 10 and supports the Y-axis stage 43 movably along the X-axis direction. The X-axis stage 42 includes an X-axis driving handle 45 and an X-axis scale 46. A specific configuration of the X-axis stage 42 is not limited, and an arbitrary movement mechanism such as a linear stage may be used.

The X-axis driving handle 45 is an operation mechanism for manually operating a movement of the X-axis stage 42. As the X-axis driving handle 45, a rotary handle is used (see FIG. 3). For example, by changing a rotation direction and rotation speed of the X-axis driving handle 45, a lateral movement direction and movement speed of the X-axis stage 42 can be changed. A specific configuration of the X-axis driving handle 45 is not limited.

The X-axis scale 46 detects an X coordinate value that indicates a position of the X-axis stage 42. The X-axis scale 46 detects, for example, a distance between a preset reference position and a current position of the X-axis stage 42 as the X coordinate value. A specific configuration of the X-axis scale 46 is not limited, and a distance sensor that uses laser light, or the like may be used as the X-axis scale 46, for example.

The Y-axis stage 43 supports the measurement table 41 movably along the Y-axis direction. The Y-axis stage 43 includes a Y-axis driving handle 47 and a Y-axis scale 48. A specific configuration of the Y-axis stage 43 is not limited, and an arbitrary movement mechanism such as a linear stage may be used. It should be noted that the X-axis stage 42 and the Y-axis stage 43 may be arranged in a manner opposite to the arrangement shown in FIG. 1. In other words, the Y-axis stage 43 may be arranged on the mount 10, the X-axis stage 46 may be arranged on the Y-axis stage 43, and the measurement table 41 may be arranged on the X-axis stage 46.

The Y-axis driving handle 47 is an operation mechanism for manually operating a movement of the Y-axis stage 43. As the Y-axis driving handle 47, for example, an operation mechanism similar to that of the X-axis driving handle 45 is used (see FIGS. 3 and 4). Of course, the configuration is not limited to this, and an arbitrary operation mechanism may be used as the Y-axis driving handle 47.

The Y-axis scale 48 detects a Y coordinate value that indicates a position of the Y-axis stage 43. The Y-axis scale 48 detects, for example, a distance between a preset reference position and a current position of the Y-axis stage 43 as the Y coordinate value. As the Y-axis scale 48, for example, a distance sensor similar to that of the X-axis scale 46 or the like is used. The present invention is not limited to this, and an arbitrary sensor or the like may be used as the Y-axis scale 48.

In this way, in the stage unit 40, the measurement table 41 (work 4) can be moved by moving the X-axis stage 42 and the Y-axis stage 43. In other words, the measurement table 41 can be moved relative to the camera 31 along the X-axis direction and the Y-axis direction that are parallel to the mounting surface 44 and orthogonal to each other.

For example, in a case where the measurement table 41 is moved by operating the X-axis stage 42, a relative position between the camera 31 and the measurement table 41 along the X-axis direction changes. This change in the relative position can be detected as a change in the X coordinate value. Specifically, by using the X coordinate value, the relative position between the camera 31 and the measurement table 41 in the X-axis direction can be expressed. Similarly, by using the Y coordinate value, the relative position between the camera 31 and the measurement table 41 in the Y-axis direction can be expressed.

In this embodiment, the X coordinate value corresponds to a first coordinate value that indicates a relative position between the image pickup unit and the mounting unit along the first direction, and the Y coordinate value corresponds to a second coordinate value that indicates the relative position between the image pickup unit and the mounting unit along the second direction. Further, the X-axis scale 46 and the Y-axis scale 48 function as a coordinate detection unit.

The switching switch 50 and the operation switch 51 will be described later in detail.

The command input unit 2 is an operation mechanism for inputting commands requisite for the measurement. The command input unit 2 is connected to the measurement machine body 1 via the control system 3, for example. Of course, the command input unit 2 may be directly connected to the measurement machine body. For example, the brightness of illumination light, the image pickup parameters of the camera 31, and the like can be controlled by operating the command input unit 2. A specific configuration of the command input unit 2 is not limited, and buttons, a dial, and the like for inputting commands requisite for the measurement may be provided as appropriate, for example.

The control system 3 includes a display unit 60, an operation unit 61, and a control unit 62. The display unit 60 is capable of displaying the measurement image and observation image of the work 4. As the display unit 60, a CRT monitor, a liquid crystal monitor, or the like is used. The operation unit 61 is, for example, a keyboard, a pointing device, a touch panel (integrated with display unit 60), or other operation apparatuses.

FIG. 2 is a block diagram showing a configuration example of the image measurement apparatus. As shown in FIG. 2, the control unit 62 includes hardware configurations requisite for a computer, such as a CPU (Central Processing Unit) 63, a ROM (Read Only Memory) 64, and a RAM (Random Access Memory) 65. The control unit 62 also includes an image input unit 66, an image memory 67, and an image output unit 68.

The image input unit 66 is an interface for inputting image data. Image data of the work 4 (image data of measurement image and image data of observation image) output from the camera 31, for example, is input to the image input unit 66.

The image memory 67 stores the image data input to the image input unit 66. Further, display image data that has been subjected to image processing by the CPU 63 is also stored in the image memory 67. As the image memory 67, for example, an HDD (Hard Disk Drive), an SSD (Solid State Drive), or the like is used.

The image output unit 68 is an interface for outputting image data. The image output unit 68 outputs the display image data stored in the image memory 67 to the display unit 60.

Connected to the CPU 63 of the control unit 62 via an input/output interface (not shown) are the X-axis scale 46, Y-axis scale 48, Z-axis scale 34, and illumination unit 32 of the measurement machine body 1, the command input unit 2, and the operation unit 61. As the input/output interface, for example, a USB (Universal Serial Bus) terminal or the like is used. In addition, a dedicated interface or the like for connecting the respective units may be used as appropriate.

FIG. 3 is a block diagram showing a functional configuration example of the control unit 62. Information processing by the control unit 62 is realized by the CPU 63 loading a predetermined program stored in the ROM 64 or the like into the RAM 65 and executing it, for example. The program is installed in the control unit 62 via various recording media, for example. Alternatively, the program may be installed in the control unit 62 via the Internet or the like.

As shown in FIG. 3, in this embodiment, an image acquisition unit 70, a scale value acquisition unit 71, a judgment unit 72, and a display control unit 73 are realized by the CPU 63 executing a program according to the present invention. Dedicated hardware may be used to realize the respective blocks.

The image acquisition unit 70 acquires image data of the measurement image and image data of the observation image regarding the work 4, that have been captured by the camera 31. The image acquisition unit 70 accesses the image memory 67 shown in FIG. 2 as appropriate, for example, and acquires the image data stored in the image memory 67. Each of the acquired pieces of image data is output to the display control unit 73.

The scale value acquisition unit 71 acquires the X coordinate value and the Y coordinate value respectively detected by the X-axis scale 46 and the Y-axis scale 48. The scale value acquisition unit 71 is capable of constantly acquiring the X coordinate value and the Y coordinate value at a predetermined sampling rate, for example. In descriptions below, both the X coordinate value and the Y coordinate value may be referred to as scale values.

FIG. 3 schematically shows a temporal change of the X coordinate value (Y coordinate value) detected by the X-axis scale 46 (Y-axis scale 48), that is, the temporal change of the scale value. The X coordinate value and the Y coordinate value acquired by the scale value acquisition unit 71 are output to the judgment unit 72.

The judgment unit 72 judges whether capturing of a measurement image by the camera 31 is possible based on information related to the relative position between the camera 31 and the measurement table 41 within a predetermined time. A state where capturing of a measurement image by the camera 31 is possible is a state where the camera 31 is capable of capturing a measurement image with allowable image pickup accuracy, for example.

In the present invention, the X coordinate value and the Y coordinate value are used as the information related to the relative position between the camera 31 and the measurement table 41. The judgment unit 72 is capable of monitoring the X coordinate value and the Y coordinate value and constantly judging whether the capturing of a measurement image by the camera 31 is possible. It should be noted that the judgment unit 72 outputs the X coordinate value and the Y coordinate value to the display control unit 73 together with the judgment result obtained by the judgment unit 72.

In a case where it is judged that the capturing of a measurement image is possible, the judgment unit 72 permits the camera 31 to capture a measurement image. In this embodiment, in a case where it is judged that the capturing of a measurement image is possible, an image pickup request signal 74 that requests the camera 31 to capture a measurement image is output.

For example, while it is judged that the capturing of a measurement image is possible, the judgment unit 72 continuously outputs the image pickup request signal 74. In this embodiment, the image pickup request signal 74 corresponds to a request signal.

The switching switch 50 switches ON/OFF an input of the image pickup request signal 74 output from the judgment unit 72, to the camera 31. In this embodiment, ON/OFF of the switching switch 50 is switched by an operation on the operation switch 51. For example, by operating the operation switch 51 to turn on the switching switch 50, the image pickup request signal 74 is input to the camera 31. As a result, a measurement image of the work 4 is captured by the camera 31.

FIG. 4 is a perspective view showing a configuration example of the operation switch 51. The operation switch 51 is a switch for executing the capturing of a measurement image by the camera 31. As shown in FIG. 4, the operation switch 51 is arranged in the vicinity of the Y-axis driving handle 47 of the Y-axis stage 43. Alternatively, the operation switch 51 may be provided in the vicinity of the X-axis driving handle 45 of the X-axis stage 42.

By arranging the operation switch 51 in the vicinity of the Y-axis driving handle 47 (X-axis driving handle 45) as the operation mechanism in this way, it becomes possible to move the work 4 and capture a measurement image at hand, and usability of the apparatus is greatly improved.

In this embodiment, a push-button-type switch including a lighting unit 52 whose lighting state changes is used as the operation switch 51. Alternatively, the operation switch 51 may be provided at an end portion of a knob for rotating the Y-axis driving handle 47 (X-axis driving handle 45), or the like. Further, for example, a rotation-type or slide-type switch or the like that is arranged along a front surface of the Y-axis driving handle 47 (X-axis driving handle 45) may be used as the operation switch 51. It should be noted that a specific configuration of the operation switch 51 is not limited, and an arbitrary operation mechanism including the lighting unit 52 may be used as the operation switch 51, for example.

In a case where the judgment unit 72 judges that the capturing of a measurement image is not possible, the image pickup request signal 74 is not output. In this case, even when the operation switch 51 is operated to turn on the switching switch, a measurement image is not captured. As a result, it becomes possible to prevent a measurement image from being captured in a state unsuited for the capturing of a measurement image, and thus avoid re-shooting due to erroneous image pickup, and the like.

It should be noted that the judgment by the judgment unit 72 on whether the capturing of a measurement image is possible is not limited to the case where it is performed constantly. For example, the judgment processing by the judgment unit 72 is started when the measurement table 41 is moved, and the judgment processing by the judgment unit 72 is ended when a certain time has elapsed since the end of the movement operation of the measurement table 41. For example, such processing may be executed.

In this processing, a state where the judgment processing by the judgment unit 72 is not carried out is a state where the measurement table 41 is still. Therefore, image pickup with less vibrations is possible before the judgment by the judgment unit 72, and thus image pickup accuracy can be maintained sufficiently high. Therefore, for example, when the operation switch 51 is operated before the judgment by the judgment unit 72, image pickup may be executed as it is without using the image pickup request signal 74 (request signal) output from the judgment unit 72 to the camera 31. In this way, even in a case where the request signal from the judgment unit 72 is not output, image pickup can be executed appropriately.

In this embodiment, the switching switch 50 and the operation switch 51 function as a switch unit that controls an input of the image pickup request signal 74 to the camera 31. The switching switch 50 may be configured as a software block by the control unit 62.

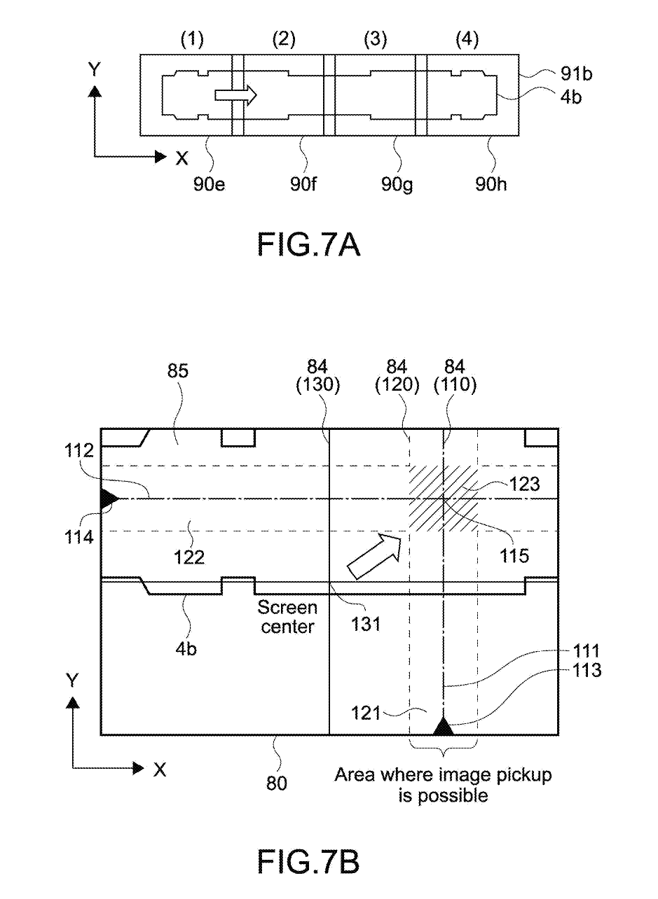

The display control unit 73 controls image display by the display unit 60. The display control unit 73 generates, for example, a measurement screen for performing an image measurement based on image data of a measurement image. In addition, the display control unit 73 generates an observation screen 80 (see FIG. 7) for observing the measurement target based on image data of an observation image. Moreover, the display control unit 73 generates a notification screen 81 for notifying the judgment result obtained by the judgment unit 72 and a completion of capturing of a measurement image by the camera 31.

It should be noted that configurations and the like of the screens to be generated by the display control unit 73 are not limited, and the measurement screen, the observation screen, and the notification screen may be configured to be displayed on the same screen, or each screen may be displayed while being switched, for example. Other arbitrary screen configurations may also be used. The screens (measurement screen, observation screen, and notification screen) generated by the display control unit 73 are stored in the image memory 67 as display image data, and is output to the display unit 60 via the image output unit 68.

FIG. 5 is a graph showing a temporal change of a scale value. An abscissa axis of the graph represents time, and an ordinate axis represents a scale value (X coordinate value or Y coordinate value).

In the graph shown in FIG. 5, as an example, a timing at which a manual movement operation of the stage (X-axis stage 42 or Y-axis stage 43) is completed is set as 0 (origin) on the abscissa axis. It should be noted that since the scale value is constantly acquired in the actual processing, the origin of the time axis, or the like is not set. The notations on the abscissa axis shown in FIG. 5 are an example for explaining an operation of the judgment unit 72 to be described below. As shown in FIG. 5, immediately after the movement of the stage is completed, a value of the scale value vibrates due to a residual vibration accompanying the movement of the stage. The value of the scale value typically converges to a constant value over time.

In the present invention, in a case where a change of the relative position between the camera 31 and the measurement table 41 falls within a predetermined range in a judgment time ΔT, the judgment unit 72 judges that the capturing of a measurement image is possible. In other words, the judgment unit 72 judges whether a change of the scale value (X coordinate value and Y coordinate value) within the judgment time ΔT falls within a predetermined range. In this embodiment, the judgment time ΔT corresponds to a predetermined time.

For judging the change in the scale value, in this embodiment, the judgment unit 72 judges whether the X coordinate value in the judgment time ΔT falls within a target range in the X-axis direction. Further, the judgment unit 72 judges whether the Y coordinate value in the judgment time ΔT falls within a target range in the Y-axis direction.

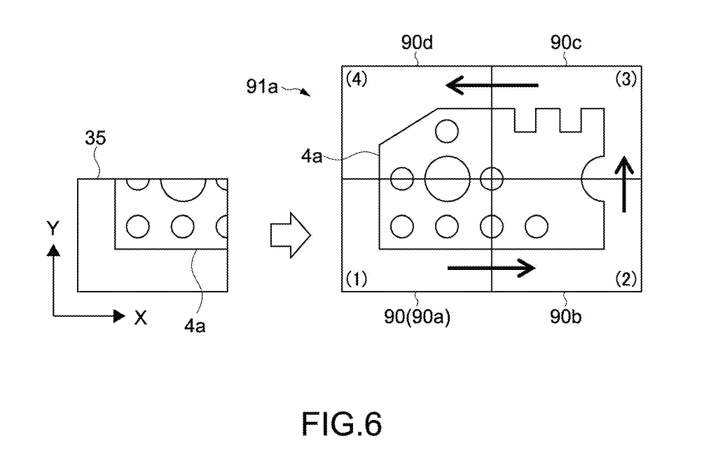

Each of the target range in the X-axis direction and the target range in the Y-axis direction is a range set using a target position for capturing a measurement image as a reference. Here, the target position is, for example, coordinates for capturing a desired measurement image. The target position is calculated as appropriate according to, for example, a size of an image pickup range 35 of the camera 31 (see FIG. 6), the shape of the work 4, and the like. Alternatively, coordinate values indicating a target position, or the like may be input by the user.

Further, the target position may be automatically updated to a new value after capturing an image of the work, for example. In other words, the next target position may be newly set in accordance with the capturing of a measurement image. In this case, the target ranges in the X-axis direction and the Y-axis direction are updated as appropriate in accordance with the update of the target position. In addition, a method of setting the target position, an update timing, and the like are not limited.

In this embodiment, the target range in the X-axis direction and the target range in the Y-axis direction respectively correspond to a first range and a second range. Further, the target position corresponds to an image pickup position for capturing a measurement image.

Hereinafter, the operation of the judgment unit 72 will be specifically described while using the scale value shown in FIG. 5 as the X coordinate value. Of course, even in a case where the scale value is used as the Y coordinate value, descriptions can be given similarly.

First, the judgment unit 72 acquires an X coordinate value at a predetermined sampling rate Δt. The predetermined sampling rate Δt is set to have a time interval similar to the sampling rate at which the scale value acquisition unit 71 acquires the X coordinate value, for example. In FIG. 5, data points acquired at the predetermined sampling rate Δt (X coordinate values) are schematically illustrated by black circles. It should be noted that in actuality, processing of sampling the X coordinate value is constantly executed.

The judgment unit 72 judges whether each of the X coordinate values acquired at the predetermined sampling rate Δt falls within a target range 49 in the X-axis direction. Specifically, the judgment unit 72 performs the judgment on each of the X coordinate values at an interval similar to the interval for acquiring the X coordinate value (predetermined sampling rate Δt).

In FIG. 5, a range between an upper limit value X0+δX and a lower limit value X0-δX with the target position X0 in the X-axis direction being a reference is set as the target range 49 in the X-axis direction. Therefore, the judgment unit 72 judges whether (X0-δX)≤Xm≤(X0+δX) is satisfied for the acquired X coordinate value Xm. It should be noted that the target range 49 in the X-axis direction is not limited to the range that centers on the target position (X0), and an arbitrary range that uses X0 as a reference may be set, for example.

In this embodiment, the judgment unit 72 judges whether all of N X coordinate values corresponding to the judgment time ΔT fall within the target range 49 in the X-axis direction. Here, the number N corresponding to the judgment time ΔT is a number with which a value obtained by multiplying a value, which is obtained by subtracting 1 from the number N, by the predetermined sampling rate Δt becomes equal to or larger than the judgment time ΔT. Specifically, the number N is a number that satisfies a relationship expressed by (N−1)*Δt≥ΔT.

For example, the number N is set to be (N−1)*Δt=ΔT. For example, in FIG. 5, the judgment unit 72 judges that an X coordinate value X1 acquired at a time T1 falls within the target range 49 in the X-axis direction. Further, all of X2, X3, . . . XN acquired after the time T1 are judged to be falling within the target range 49 in the X-axis direction. In this case, a time required before X1 to XN are acquired is (N−1)*Δt. Therefore, at a time T1+ΔT, it is judged that an amplitude of the X coordinate value within the judgment time ΔT is within the target range 49 in the X-axis direction.

By setting the number N corresponding to the judgment time ΔT in this way, it is possible to judge whether the X coordinate value has fallen within the target range 49 in the X-axis direction during the judgment time ΔT, for example. Specifically, in a case where the X coordinate value has been kept within the target range 49 in the X-axis direction continuously for N times, the judgment unit 72 can judge that the vibration of the X coordinate value is within the predetermined range during the judgment time ΔT.

From another viewpoint, it can also be said that a desired judgment time ΔT can be set by appropriately setting the number N according to the predetermined sampling rate Δt. Accordingly, the judgment time ΔT can be set easily, and calculation processing and the like can be simplified. In this way, by appropriately setting the judgment time ΔT or the number N, it can be judged that the residual vibration of the X-axis stage 42 is within an allowable range (target range 49 in X-axis direction).

The judgment unit 72 similarly makes a judgment on the Y coordinate value of the Y-axis stage 43. In other words, the judgment unit 72 acquires the Y coordinate value at the predetermined sampling rate Δt and judges whether all of the Y coordinate values in the number N corresponding to the judgment time ΔT fall within a target range in the Y-axis direction (Y0±δY). Accordingly, it becomes possible to judge whether the residual vibration of the Y-axis stage 43 is within an allowable range.

In a case where all of the X coordinate values in the number N corresponding to the judgment time ΔT fall within the target range in the X-axis direction and all of the Y coordinate values in the number N corresponding to the judgment time ΔT fall within the target range in the Y-axis direction, the judgment unit 72 judges that the capturing of a measurement image is possible. Accordingly, it becomes possible to capture the measurement image in a state where vibrations in the X-axis direction and the Y-axis direction are sufficiently small, and thus capture the measurement target with high accuracy.

It should be noted that in the example shown in FIG. 5, the residual vibration after completion of the movement operation of the stage is shown, and the judgement operation is executed with respect to the residual vibration. In actuality, the scale value is constantly monitored regardless of whether the movement operation is completed. In other words, it is judged whether the amplitude of each of the X coordinate values and Y coordinate values within the judgment time ΔT is constantly within the target ranges in the X-axis direction and the Y-axis direction.

Accordingly, it becomes possible to evaluate the vibration of the stage (including residual vibration) regardless of the timing of completion of the movement operation, or the like. Of course, it is also possible to detect the timing at which the movement operation is completed and execute the vibration convergence judgment after that. Further, by setting the target ranges in the X-axis direction and the Y-axis direction with reference to the target position, the movement of the stage (work 4) to desired coordinates can be realized with high accuracy.

The judgment time ΔT is set to a default value, for example. In other words, the number N corresponding to the judgment time ΔT is set to a default value. Further, for example, the judgment time ΔT and the number N may be set automatically according to a mass of the work 4, an acceleration for decelerating/stopping the stage, and the like. Further, for example, the judgment time ΔT and the number N may be set as appropriate by the user.

For example, in a case where the judgment time ΔT (number N) is set to be small, a time required for judging the vibration of the scale value is shortened. As a result, for example, it becomes possible to shorten the time from the completion of the movement operation of the stage to the capturing of a measurement image. Further, for example, in a case where the judgment time ΔT (number N) is set to be large, it becomes possible to capture the measurement image in a state where the residual vibration is sufficiently converged. The method of setting the judgment time ΔT and the number N is not limited.

A size of the target range in the X-axis direction (2*δX) and a size of the target range in the Y-axis direction (2*δY) are determined so as to exert desired image pickup accuracy. For example, the size of each of the target ranges is determined based on a pixel size of the camera 31, a resolution of the measurement image, and the like. Accordingly, it becomes possible to capture a measurement image with desired image pickup accuracy. It should be noted that the method of setting the size of the target ranges in the X-axis direction and the Y-axis direction, or the like is not limited. For example, the size of each of the target ranges may be set as appropriate in accordance with the type of the work 4, the usage of the measurement image, and the like.

In this embodiment, the sizes of the target ranges in the X-axis direction and the Y-axis direction are set to be equal to each other. Specifically, it is judged that the capturing of a measurement image is possible in a case where the vibrations of the measurement table 41 in the X-axis direction and Y-axis direction with respect to the camera 31 are within the same level. As a result, for example, calculations and the like for judging the state where the capturing of a measurement image is possible becomes easy. It should be noted that different sizes may be set for the respective directions depending on the configurations of the mechanisms for moving the X-axis and Y-axis stages 42 and 43, for example.

It is assumed that the judgment unit 72 has judged that the capturing of a measurement image is possible. In this case, the display control unit 73 generates the notification screen 81 for notifying the judgment result indicating that the capturing of a measurement image is possible. The generated notification screen 81 is displayed on the display unit 60. FIG. 4 shows an example of the notification screen 81 including a message “please capture image”.

By viewing the notification screen 81 displayed on the display unit 60, the user can recognize that the capturing of a measurement image has become possible. In this case, the judgment unit 72 is outputting the image pickup request signal 74, and the capturing of a measurement image is permitted. Therefore, by operating the operation switch 51, the user can capture a measurement image of the work 4.

When the capturing of the measurement image is completed, the display control unit 73 generates the notification screen 81 for notifying the completion of the capturing of the measurement image by the camera 31, and causes the notification screen 81 to be displayed on the display unit 60. For example, as shown in FIG. 4, a message “please move stage” is displayed on the notification screen 81.

By viewing the notification screen 81 displayed on the display unit 60, the user can recognize that the capturing of the measurement image has been completed. As a result, the movement of the X-axis stage 42 and the Y-axis stage 43 can be started toward the next image pickup position, for example.

It should be noted that the method of notifying the judgment result of the judgment unit 72 and the completion of the capturing of the measurement image via the notification screen 81 is not limited to the method that uses messages. For example, the judgment result and the like may be notified by a method of displaying symbols (icons etc.) corresponding to the respective states or changing colors, shapes, and the like of the symbols. In this embodiment, the display control unit 73 and the display unit 60 function as a notification unit.

FIG. 6 is a diagram for explaining an example of capturing of a measurement image. Hereinafter, a case of capturing an image of a work 4a larger than a field of view (image pickup range 35) of the camera 31 will be described.

In the image measurement apparatus 100, image stitching is performed for capturing an image of the work 4a larger than the image pickup range 35 of the camera 31. In the image stitching, a measurement image 90 of the work 4a is captured a plurality of times while moving the image pickup range 35, and a synthetic image 91a of the work 4a is generated by synthesizing the plurality of measurement images 90. FIG. 6 schematically shows one image pickup range 35 (left-hand side) and the synthetic image 91a of the work 4a (right-hand side).

In this embodiment, the display control unit 73 generates a position screen 82 that indicates the current position, which is the current relative position between the camera 31 and the measurement table 41, and the target position for capturing the measurement image 90. The generated screen 82 is displayed on the display unit. An example of the position screen 82 is displayed on the display unit 60 shown in FIG. 3.

The current position is, for example, the current X coordinate value of the X-axis stage 42 and the current Y coordinate value of the Y-axis stage 43. Therefore, the respective coordinate values displayed as the current position are updated as appropriate in accordance with the movements of the X-axis stage 42 and the Y-axis stage 43.

The target position is calculated as appropriate in accordance with the capturing of the measurement image 90. Therefore, the next target position is displayed on the position screen 82 every time an image is captured, for example. In addition, a timing of switching display of the target position and the like are not limited.

First, the X-axis stage 42 and the Y-axis stage 43 are moved to a first target position. The user moves the X-axis stage 42 and the Y-axis stage 43 such that the values of the current position approach the values of the target position (first target position), for example. Accordingly, the work 4a can be moved to the first target position. When the movement to the first target position is completed and it is judged by the judgment unit 72 that the capturing of a measurement image is possible, the message “please capture image” is displayed on the display unit 60.

When the user operates the operation switch 51, a first measurement image 90a (measurement image 90) is captured. For example, the first measurement image 90a is stored while being associated with the current position at the time of image pickup. When capturing of the first measurement image 90a is completed, the message “please move stage” is displayed on the display unit 60. Further, the next target position (second target position) is displayed on the display unit 60. As a result, the user can move the stage to the second target position.

The X-axis stage 42 and the Y-axis stage 43 are moved to the first to fourth target positions so that the first to fourth measurement images 90a to 90d are captured. For example, the first to fourth measurement images 90a to 90d are synthesized based on the positions at which the respective measurement images are captured (current position at time of image pickup). Accordingly, the synthetic image 91a including an entire image of the work 4a is generated. It should be noted that the method of generating a synthetic image 91a of the work 4a is not limited, and image processing such as pattern matching, or the like may be used as appropriate.

In this way, in the image measurement apparatus 100, it is possible to execute a manual stitching operation of manually moving the stage and performing image stitching. In the manual stitching operation, for example, it is possible to capture only a necessary part of the work 4a or capture the work 4a according to the shape. In the image measurement apparatus 100, it is possible to efficiently perform the image pickup operation by notifying the user of the movement of the stage in the manual stitching operation and the image pickup timing of the work 4a.

FIG. 7 are schematic diagrams for explaining examples of the observation screen 80 and the measurement image. FIG. 7A is a schematic diagram showing an example of the measurement image captured in the image stitching. FIG. 7B is a schematic diagram showing an example of the observation screen 80.

In FIG. 7A, images of a work 4b elongated in the X-axis direction are captured along the X-axis direction, and first to fourth measurement images 90e to 90h are captured. As shown in FIG. 7A, the first to fourth measurement images 90e to 90h are captured such that adjacent images partially overlap one another. Accordingly, even in a case where the target position for capturing the measurement image and the position at which the measurement image is captured are somewhat deviated, a synthetic image 91b of the work 4b can be created seamlessly.

FIG. 7B shows the observation screen 80 in a case where the work 4b shown in FIG. 7A is observed. In this embodiment, the display control unit 73 generates an auxiliary image 84 that assists the capturing of the measurement image, and the auxiliary image 84 and the observation image 85 are displayed on the display unit 60. A screen including this auxiliary image 84 and the observation image 85 becomes the observation screen 80.

As shown in FIG. 7B, the auxiliary image 84 is displayed while being superimposed on the observation image 85. The auxiliary image 84 includes a navigation line image 110, an image-pickup-possible area image 120, and a centerline image 130.

The navigation line image 110 is an image that indicates a target position for capturing a measurement image. In FIG. 7B, the navigation line image 110 is schematically illustrated by dashed-dotted lines 111 and 112 vertical to the X-axis direction and the Y-axis direction, respectively, and markers 113 and 114 respectively indicating the positions of the dashed-dotted lines 111 and 112. In the navigation line image 110, a target position for capturing a measurement image is instructed by an intersection 115 of the dashed-dotted lines 111 and 112. It should be noted that in addition to graphic display of the navigation line image 110 and the like, coordinates of centers of the dashed-dotted lines 111 and 112 (coordinates of intersection 115) and the like may be displayed as numerical values (X, Y) on the screen.

The image-pickup-possible area image 120 is an image that instructs an area where the capturing of a measurement image is possible. The area where the capturing of a measurement image is possible is an area where a measurement image for seamlessly generating the synthetic image 91a can be captured, for example. This area is set in accordance with, for example, an overlapping degree of the adjacent images described with reference to FIG. 7A, a size of the work 4b, and the like. Of course, the present invention is not limited to this.

In FIG. 7B, the image-pickup-possible area image 120 is schematically illustrated by dotted lines surrounding the navigation line image 110. In the image-pickup-possible area image 120, a rectangular first area 121 surrounding the dashed-dotted line 111 vertical to the X-axis direction and a rectangular second area 122 surrounding the dashed-dotted line 112 vertical to the Y-axis direction are displayed. An area where the capturing of a measurement image is possible is instructed by an intersection area 123 (hatched area) where the first area 121 and the second area 122 intersect. It should be noted that the hatching lines are not displayed in the actual image.

The navigation line image 110 and the image-pickup-possible area image 120 are generated based on, for example, the current position of the stage (current X coordinate value and Y coordinate value) and the target position. For example, when the stage is moved and the current position is updated, the navigation line image 110 is updated as appropriate so as to instruct the target position. In addition, the image-pickup-possible area image 120 is updated as appropriate in accordance with the update of the navigation line image 110. It should be noted that the generation method, design, and the like of the navigation line image 110 and the image-pickup-possible area image 120 are not limited.

Further, the navigation line image 110 and the image-pickup-possible area image 120 are displayed in a case where a distance between the current position and the target position becomes shorter than a predetermined distance. Furthermore, only one of the navigation line image 110 and the image-pickup-possible area image 120 may be displayed. In addition, the method of displaying the navigation line image 110 and the image-pickup-possible area image 120, and the like are not limited. In this embodiment, the navigation line image 110 and the image-pickup-possible area image 120 correspond to a guide image.

The centerline image 130 is an image that shows a center of an observation image 85. In FIG. 7B, the center line image 130 representing a screen center 131 of the observation image 85 (observation screen 80) is indicated by a solid line.

In the observation screen 80, when the stage is moved, for example, the navigation line image 110 and the image-pickup-possible area image 120 move together with the work 4b. It should be noted that the position of the centerline image 130 in the observation screen 80 (screen center 131) does not change.

For example, by appropriately moving the X-axis and Y-axis stages 42 and 43 so that the screen center 131 and the intersection 115 of the navigation line image 110 intersect with each other, the X-axis and Y-axis stages 42 and 43 can be moved to the target position. By referencing the navigation line image 110 in this way, an intuitive stage operation becomes possible, and usability of the apparatus is greatly improved.

Further, an operation of stopping the movement of the stage and capturing the measurement image may be performed at a timepoint the screen center 131 is included in the intersection are 123 (area where capturing of measurement image is possible). Even in this case, it is possible to appropriately generate the synthetic image 91b of the work 4b by using the captured measurement images. By referencing the image-pickup-possible area image 120 in this way, it becomes unnecessary to precisely position the X-axis and Y-axis stages 42 and 43, and the capturing of the measurement image can be promptly executed. Accordingly, it becomes possible to sufficiently shorten a time required for the observation.

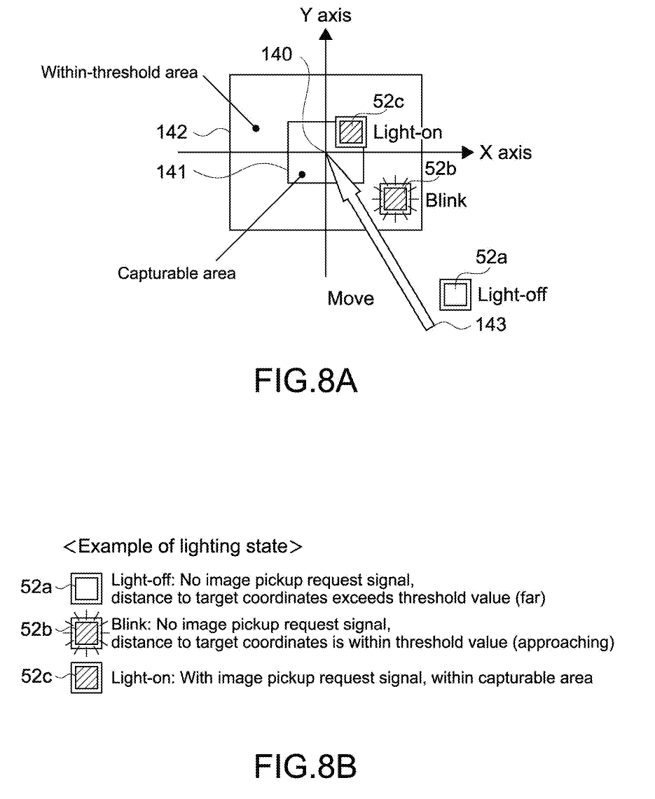

FIG. 8 are diagrams for explaining an operation of the lighting unit 52 of the operation switch 51. FIG. 8A is a schematic diagram showing a relationship between the movement of the stage and a lighting state of the lighting unit 52. FIG. 8B is a diagram showing an example of the lighting state of the lighting unit 52.

In FIG. 8A, a target position 140, an area where capturing of a measurement image is possible (capturable area 141), and a within-threshold area 142 are shown. The within-threshold area 142 is set based on a predetermined threshold value regarding a distance between the target position 140 and the current position, for example. In FIG. 8A, a rectangular area surrounding the capturable area 141 is set as the within-threshold area 142. It should be noted that the shape, size, and the like of the within-threshold area 142 are not limited. In addition, in FIG. 8A, a movement path of the stage from outside the within-threshold area 142 toward the target position 140 is schematically illustrated by an arrow 143.

As shown in FIG. 8A, the lighting state of the lighting unit 52 changes in accordance with the movement of the stage. In this embodiment, the lighting state of the lighting unit 52 changes based on the distance between the current position, which is the current relative position between the camera 31 and the measurement table 41, and the target position 140 for capturing the measurement image, and the judgment result obtained by the judgment unit 72.

For example, as shown in FIG. 8B, in a case where the image pickup request signal 74 from the judgment unit 72 is not output and the distance between the current position and the target position is larger than the predetermined threshold value, the lighting unit 52 is put to a light-off state 52a. This corresponds to, for example, a case where the stage is moving outside the within-threshold area 142. By turning off the lighting unit 52, it is possible to notify that the distance to the target position is far.

Further, in a case where the image pickup request signal 74 is not output and the distance between the current position and the target position is smaller than the predetermined threshold value, the lighting unit 52 is put to a blinking state 52b. This corresponds to, for example, a case where the stage is moving inside the within-threshold area 142. By the blink of the lighting unit 52, it is possible to notify that the distance to the target position is becoming smaller.

Furthermore, in a case where the image pickup request signal 74 is being output and the current position is in the capturable area 141, the lighting unit 52 is put to a lit state 52c. This corresponds to, for example, a case where the stage is stopped in the capturable area 141 and it is judged that the capturing of a measurement image is possible. Since the lighting unit 52 is lit, it is possible to notify that the capturing of a measurement image is possible.

By changing the lighting state of the lighting unit 52 in this way, it is possible to notify the user of the timing of capturing a measurement image. Further, since the lighting unit 52 is provided in the operation switch 51, the user can reference the lighting state while checking the operation at hand. As a result, it becomes possible to efficiently perform an operation of moving the stage and capturing a measurement image, and the like, and thus exert high operability.

It should be noted that the conditions for changing the lighting state of the lighting unit 52 and the like are not limited, and other conditions may be set as appropriate. Further, for example, processing of changing the lighting state, or the like may be executed based on at least one of the distance between the current position and the target position 140 and the judgment result obtained by the judgment unit 72. Furthermore, the present invention is not limited to the case of turning off/blinking/lighting the lighting unit 52, and the lighting state may be expressed by changing a color, a blinking interval, and the like of the lighting unit 52.

As described above, in the image measurement apparatus 100 according to this embodiment, the camera 31 and the measurement table 41 can be moved relatively, and the work 4 placed on the measurement table 41 is captured by the camera 31. A judgment on whether the capturing of a measurement image is possible is made based on information related to the relative position between the camera 31 and the measurement table 41 within the predetermined time. Accordingly, it becomes possible to capture an image of the work 4 with high accuracy in an observation accompanied by a movement of the image pickup range 35.

In capturing a measurement target while moving the image pickup range, a method of taking in an image while presetting a standby time is conceivable. For example, the residual vibration accompanying the stop of the stage may differ depending on the mass of the work, the acceleration for decelerating/stopping the stage, and the like, and thus there is a possibility that a problem in which a timing of capturing an image in a state where measurement accuracy can be secured cannot be grasped will arise. Therefore, the standby time for taking in an image is set based on a measurement result of each work, for example, and a margin is added in many cases. As a result, there is a possibility that it will take time to perform the image stitching operation and the like.

In the image measurement apparatus 100 according to this embodiment, the judgment on whether the capturing of a measurement image is possible is made based on the scale values (X coordinate value and Y coordinate value) of the X-axis and Y-axis stages 42 and 43. The judgment result is displayed on the display unit 60 and notified to the user.

In this way, since the permission to take in a measurement image (image pickup permission) is notified when the image pickup accuracy for capturing a measurement image can be secured, the user can grasp the timing of capturing a measurement image. As a result, the user can constantly capture the work 4 with desired image pickup accuracy.

Further, by judging the state where the capturing of a measurement image is possible, it is possible to keep the image pickup accuracy of the measurement image constant irrespective of a case where the users differ, a case where the type of the work 4 differs, and the like, for example. As a result, variances in the image pickup accuracy, and the like can be suppressed, and image measurement quality can be maintained.

In this embodiment, the judgment on whether the capturing of a measurement image is possible is made by judging whether the residual vibration of the stage within the judgment time ΔT is within an allowable range. Therefore, it is possible to notify the image pickup permission at a timing where it is judged that desired image pickup accuracy is secured. As a result, an unnecessary standby time or the like required before image pickup is eliminated, and the stitching image acquisition time, that is, a measurement throughput, can be sufficiently shortened.

The scale value of the stage is used for the judgment of the residual vibration. Therefore, it is possible to perform residual vibration judgment processing and the like without newly providing a detection mechanism for detecting a vibration, and the like. Accordingly, it becomes possible to simplify the configuration of the apparatus and suppress manufacturing costs of the apparatus.

### Second Embodiment

An image measurement apparatus according to a second embodiment of the present technology will be described. In descriptions hereinafter, descriptions on configurations and operations similar to those of the image measurement apparatus 100 described in the above embodiment will be omitted or simplified.

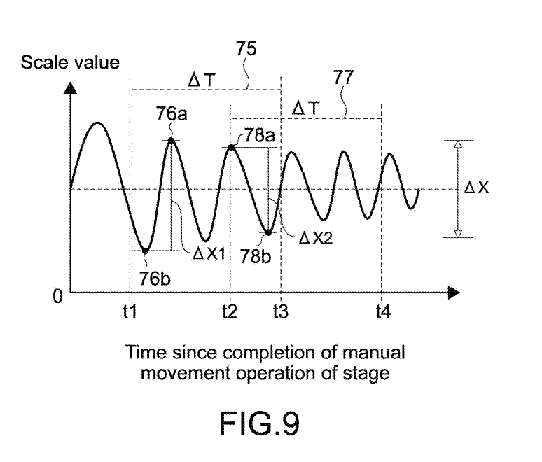

FIG. 9 is a graph showing a temporal change of the scale value. In FIG. 9, the temporal change of the scale value similar to that of the graph shown in FIG. 5 is shown. In this embodiment, for judging the change of the scale value, the judgment unit 72 calculates a difference between a maximum value and minimum value of the X coordinate value in the judgment time ΔT, and a difference between a maximum value and minimum value of the Y coordinate value in the judgment time ΔT. Then, it is judged whether capturing of a measurement image is possible based on the calculated difference regarding the X coordinate value and the calculated difference regarding the Y coordinate value.

Hereinafter, the operation of the judgment unit 72 will be specifically described while using the scale value shown in FIG. 9 as the X coordinate value. Of course, even in a case where the scale value is set as the Y coordinate value, the descriptions can be given similarly.

First, the judgment unit 72 calculates a maximum value and minimum value of the X coordinate values in the judgment time ΔT. As shown in FIG. 9, for example, the judgment unit 72 calculates a maximum value 76a and minimum value 76b of the X coordinate values in a first section 75 from a time t1 to a time t3 after the judgment time ΔT. For example, the judgment unit 72 calculates the maximum value 76a and minimum value 76b in the first section 75 at a timing the time t3 is reached.

The judgment unit 72 calculates a difference ΔX1 between the maximum value 76a and minimum value 76b in the first section 75 and judges whether the calculated difference ΔX1 is smaller than a first threshold value ΔX. In the example shown in FIG. 9, the difference ΔX1 in the first section 75 is larger than the first threshold value ΔX. Therefore, at the time t3, it is judged that an amplitude of the X coordinate values in the judgment time ΔT (amplitude of residual vibration of X-axis stage 42) is larger than the first threshold value ΔX. In this case, the judgment processing on the X coordinate values by the judgment unit 72 is continued. It should be noted that FIG. 9 schematically shows the first threshold value ΔX.

In a second section 77 from a time t2 to a time t4 after the judgment time ΔT, a difference ΔX2 between a maximum value 78a and minimum value 78b of the X coordinate values is smaller than the first threshold value ΔX. Therefore, at the time t4, it is judged that the amplitude of the X coordinate values in the judgment time ΔT is smaller than the first threshold value ΔX. As a result, it can be judged that the residual vibration of the X-axis stage 42 is within an allowable range (first threshold value ΔX).

The judgment unit 72 similarly makes a judgment on the Y coordinate values of the Y-axis stage 43. Specifically, the judgment unit 72 calculates a maximum value and minimum value of the Y coordinate values in the judgment time ΔT. Then, a judgment is made on whether the difference between the calculated maximum value and minimum value is smaller than a second threshold value ΔY. Accordingly, it becomes possible to judge whether the residual vibration of the Y-axis stage 43 is within an allowable range.

The judgment unit 72 judges that the capturing of a measurement image is possible in a case where the difference between the maximum value and minimum value of the X coordinate values in the judgment time ΔT is smaller than the first threshold value ΔX and the difference between the maximum value and minimum value of the Y coordinate values in the judgment time ΔT is smaller than the second threshold value ΔY. Accordingly, it becomes possible to capture the measurement image in a state where the vibrations in the X-axis direction and the Y-axis direction are sufficiently small and thus capture the measurement target with high accuracy.

It should be noted that the example shown in FIG. 9 shows the residual vibration after the completion of the movement operation of the stage, and the judgment operation is executed with respect to the residual vibration. In actuality, the scale value is constantly monitored regardless of whether the movement operation is completed. In other words, it is constantly judged whether the respective amplitudes of the X coordinate values and Y coordinate values within the judgment time ΔT are larger than the first and second threshold values ΔX and ΔY.

Accordingly, it becomes possible to evaluate the vibration of the stage (including residual vibration) regardless of the timing of completion of the movement operation or the position of the stage. Of course, it is also possible to detect the timing at which the movement operation is completed and execute the vibration convergence judgment after that.

The judgment time ΔT is set to a default value, for example. Further, for example, the judgment time ΔT may be automatically set in accordance with the mass of the work 4, the acceleration for decelerating/stopping the stage, and the like. Furthermore, for example, the judgment time ΔT may be set as appropriate by the user.

For example, in a case where the judgment time ΔT is set to be small, a time required for judging the vibration of the scale value is shortened. As a result, for example, it becomes possible to shorten the time from the completion of the movement operation of the stage to the capturing of a measurement image. Further, for example, in a case where the judgment time ΔT is set to be large, it becomes possible to capture the measurement image in a state where the residual vibration is sufficiently converged. It should be noted that the method of setting the judgment time ΔT is not limited. In this embodiment, the judgment time ΔT corresponds to a predetermined time.

The first threshold value ΔX and the second threshold value ΔY are determined so that desired image pickup accuracy can be exerted. For example, the values of the respective threshold values are determined based on the pixel size of the camera 31, the resolution of the measurement image, and the like. Accordingly, it becomes possible to capture the measurement image with desired image pickup accuracy. It should be noted that the method of setting the first threshold value ΔX and the second threshold value ΔY is not limited. For example, the respective threshold values may be set as appropriate in accordance with the type of the work 4, the usage of the measurement image, and the like.

In this embodiment, the first threshold value ΔX and the second threshold value ΔY are set to be equal to each other. Specifically, it is judged that the capturing of a measurement image is possible in a case where the vibrations of the measurement table 41 in the X-axis direction and Y-axis direction with respect to the camera 31 are within the same level. As a result, for example, calculations and the like for judging the state where the capturing of a measurement image is possible becomes easy. It should be noted that different threshold values may be set for the respective directions depending on the configurations of the mechanisms for moving the X-axis and Y-axis stages 42 and 43, for example.

### Third Embodiment

In the above embodiments, it is judged whether the capturing of a measurement image is possible based on the scale values (X coordinate value and Y coordinate value) of the X-axis and Y-axis stages 42 and 43. In a third embodiment, the judgment on whether the capturing of a measurement image is possible is made using an image captured by the camera 31 instead of the scale values.

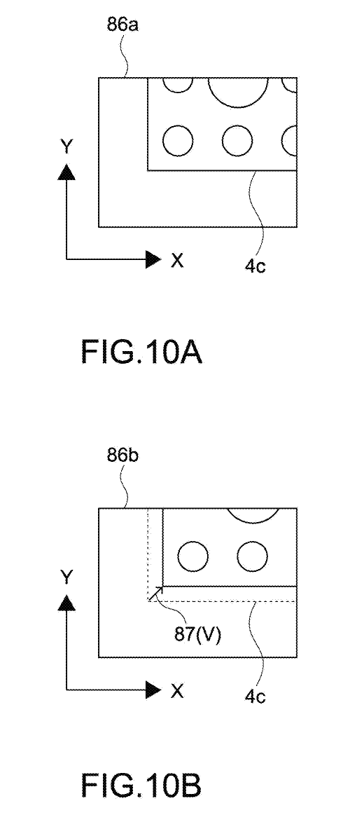

FIG. 10 are schematic diagrams showing an example of images of a work 4c captured at mutually-different timings. FIG. 10A is a schematic diagram showing a first image 86a of the work 4c captured at a first timing. FIG. 10B is a schematic diagram showing a second image 86b of the work 4c captured at a second timing after the first timing.

The first and second images 86a and 86b are images captured after the movement operation of the stage is completed. In other words, the first image 86a is captured at the first timing after the movement operation of the stage is completed. Then, the second image 86b is captured at the second timing after the first timing.

As described in the above embodiments, a residual vibration and the like may remain in the stage after the movement operation is completed. Therefore, even in a case where the movement operation of the stage is completed, the relative position between the camera 31 and the measurement table 41 may change to thus change the position of the work 4c within an image to be captured.

For example, as shown in FIGS. 10A and 10B, in the first image 86a and the second image 86b, the positions of the work 4c in the respective images differ from each other. Specifically, due to a change in the relative position between the camera 31 and the measurement table 41, that has occurred between the first timing and the second timing, a positional deviation of the work 4c occurs between the respective images. It should be noted that in FIG. 10B, the position of the work 4c at the first timing is indicated by a dotted line, and a deviation between the first and second images 86a and 86b is schematically illustrated by an arrow 87.

In a case where the relative position between the camera 31 and the measurement table 41 changes in this way, a deviation occurs between the images captured at mutually-different timings (first and second images 86a and 86b). It is possible to detect a change in the relative position between the camera 31 and the measurement table 41 based on this deviation between the images.

It should be noted that in FIGS. 10A and 10B, the first and second images 86a and 86b deviated along the mounting surface 44 (XY direction) of the measurement table 41 are illustrated. In this case, the deviation between the images is detected as deviations in the X-axis direction and the Y-axis direction. The present invention is not limited to this, and a deviation between the camera 31 and the measurement table 41 in the Z-axis direction may be detected from the first and second images 86a and 86b, for example.

The deviation in the Z-axis direction corresponds to, for example, a deviation from a focal position of the camera 31 (defocus). When the defocus changes, an outline or the like of the work 4c in the image changes. For example, it is possible to detect the deviation in the Z-axis direction by detecting a change in the outline or the like of the work 4C using a technology of edge detection and the like. Accordingly, it becomes possible to accurately detect a deviation amount in the Z-axis direction (residual vibration in longitudinal direction, etc.). This deviation amount in the Z-axis direction may be used in the judgment processing or the like described below.

In this embodiment, a calculation unit that calculates a deviation amount V of the first and second images 86a and 86b based on the first and second images 86a and 86b captured by the camera 31 at mutually-different timings is provided. The calculation unit is configured as a functional block by a CPU or the like, for example. The method of configuring the calculation unit is not limited, and dedicated hardware or the like for realizing the calculation unit may be used, for example.

The calculation unit calculates the deviation amount V of the first and second images 86a and 86b using, for example, a predetermined image processing algorithm. The calculated deviation amount V is, for example, a magnitude of a vector (arrow 87 in FIG. 10B) indicating a deviation direction or the like. The present invention is not limited to this, and a deviation amount between the images in the longitudinal direction and a deviation amount in the lateral direction may be respectively calculated as the deviation amount V.

As the predetermined image processing algorithm, a phase-only correlation method is used, for example. In the phase-only correlation method, a Fourier transform is performed on each of the first and second images 86a and 86b, and phase components of the respective images are extracted. By correlating the extracted phase components, the deviation between the first and second images 86a and 86b can be calculated. By using the phase-only correlation method, it is possible to detect the deviation amount V with high accuracy of a subpixel level.

The type of the image processing algorithm and the like are not limited, and the deviation amount V may be calculated using image matching, machine learning, or the like, for example. In addition, an arbitrary method with which the deviation amount V between the first and second images 86a and 86b can be calculated may be used as appropriate.

Further, in this embodiment, the judgment unit judges whether capturing of a measurement image is possible based on the calculated deviation amount V. Here, the judgment unit may be the judgment unit 72 described in the above embodiments, or may be configured as a functional block different from the judgment unit 72. Hereinafter, a method of judging a state where capturing of a measurement image is possible based on the deviation amount will be described in detail.

First, the first and second images 86a and 86b are captured by the camera 31 at mutually-different timings. In this embodiment, images are constantly captured by the camera 31 at predetermined time intervals. In this case, of the continuously-captured images, a previously-captured image becomes the first image 86a, and an image captured later becomes the second image 86b. The predetermined time intervals are not limited and may be set as appropriate according to, for example, a processing speed of the calculating unit and the like.

It should be noted that the method of capturing the first and second images 86a and 86b, or the like is not limited. For example, observation images for observing the work 4, that have been captured by the camera 31, may be used as the first and second images 86a and 86b. In this case, of the observation images captured at a predetermined sampling rate, images whose image pickup intervals are equal to the predetermined time intervals are used as the first and second images 86a and 86b. In addition, an arbitrary method of capturing the first and second images 86a and 86b may be used.

The first and second images 86a and 86b are input to the calculation unit via the image acquisition unit 70. The calculation unit calculates the deviation amount V of the first and second images 86a and 86b using a predetermined image processing algorithm. The calculated deviation amount V is output to the judgment unit.

It should be noted that images captured by the camera 31 are constantly input to the calculation unit at predetermined time intervals. Therefore, the calculation unit can constantly calculate the deviation amount V of the first and second images 86a and 86b. Accordingly, it becomes possible to easily monitor the change in the relative position between the camera 31 and the measurement table 41.

The judgment unit compares the calculated deviation amount V and a predetermined threshold value V0. The predetermined threshold value V0 is set such that desired image pickup accuracy is exerted. For example, the predetermined threshold value V0 is set to be 70% the amplitude of an allowable fluctuation (residual vibration). Of course, the present invention is not limited to this, and the predetermined threshold value V0 may be set as appropriate in accordance with the type of the work or the like.

As described above, the residual vibration converges with time (see FIG. 5). For example, a deviation amount V larger than the predetermined threshold value V0 may be calculated in a state where the residual vibration is sufficiently large (immediately after stop of movement operation, etc.). In other words, it can be seen that the residual vibration is sufficiently large in a case where the deviation amount V is larger than the predetermined threshold value V0. It should be noted that even in a state where the residual vibration is sufficiently large, the deviation amount V may become smaller than the predetermined threshold V0 depending on the image pickup timing.

In a state where the residual vibration of the stage is sufficiently converged, for example, the deviation amount V becomes smaller than the predetermined threshold value V0. In other words, when the deviation amount V is smaller than the predetermined threshold value V0, there is a possibility that the residual vibration of the stage is sufficiently converged.

In this embodiment, in a case where the deviation amounts V calculated by the calculation unit continuously for a predetermined number of times are smaller than the predetermined threshold value V0, the judgment unit judges that the capturing of a measurement image is possible. In other words, it is judged that the residual vibration is sufficiently converged in a case where a state where the residual vibration of the stage is highly likely converged continues for a predetermined number of times. Accordingly, it becomes possible to capture the measurement image in a state where the vibration is sufficiently small.

The predetermined number of times is set to, for example, 3 times. Therefore, the judgment unit judges whether the deviation amount V is smaller than the predetermined threshold value V0 continuously for 3 times. Accordingly, the convergence of the residual vibration can be judged in a short time. Of course, the present invention is not limited to this, and the predetermined number of times may be set to other values.

In the descriptions above, the first and second images 86a and 86b are captured after the movement operation of the stage is completed. In actuality, the camera 31 constantly captures images at predetermined time intervals regardless of whether the movement operation is completed. Therefore, it is possible to constantly monitor the deviation amount between the images captured at different timings. As a result, it becomes possible to evaluate the vibration of the stage (including residual vibration) regardless of the timing of the completion of the movement operation, or the like.

By using the deviation amount between the images captured by the camera at mutually-different timings in this way, it is possible to easily judge whether the residual vibration is within an allowable level. As a result, it becomes possible to easily judge whether capturing of a measurement image is possible and capture the measurement image with high accuracy.

### OTHER EMBODIMENTS

The present invention is not limited to the embodiments described above, and various other embodiments can be realized.

In the first and second embodiments, the measurement table 41 is moved using the X-axis and Y-axis stages 42 and 43. The present invention is not limited to this, and the camera may be configured to be movable along the X-axis direction and the Y-axis direction. In this case, it is possible to judge whether capturing of a measurement image is possible by appropriately detecting a residual vibration and the like caused by the stop of the movement of the camera based on a scale value indicating the position of the camera, and the like. Further, for example, the present invention is also applicable to a case where the camera and the measurement table are configured to be movable.

In the descriptions above, the X-axis stage 42 and the Y-axis stage 43 are manually moved using the X-axis driving handle 45 and the Y-axis driving handle 47. The present invention is not limited to this, and each of the stages may be an electric stage that can be moved by an electric switch or the like, for example. The electric switch is a controller for inputting, for example, a movement direction and movement speed of the stage, and the like, and is configured as appropriate by using a button, a lever, a dial, a trackball, or the like. Also when operating the electric switch to move the respective stages, for example, it is possible to judge whether capturing of a measurement image is possible by judging the residual vibration accompanying the stop of the movement of the respective stages. Further, for example, the present invention is also applicable to a case where the movements of the X-axis and Y-axis stages are controlled automatically.

In the embodiments above, the notification of the judgment result (see FIG. 4) and the output of the image pickup request signal 74 are performed in accordance with the judgment result obtained by the judgment unit 72. The present invention is not limited to this, and either the judgment result notification processing or the processing of outputting the image pickup request signal 74 may be performed in accordance with the judgment result, for example. Even in such a case, it is possible to accurately capture an image of the work.

As the method of detecting a change in the relative position between the camera and the measurement table, the detection of the scale value (X coordinate value and Y coordinate value) described in the first and second embodiments and the calculation of the deviation amount V of the first and second images, that has been described in the third embodiment, may both be executed. Accordingly, it becomes possible to accurately detect the change in the relative position between the camera and the measurement table. As a result, it becomes possible to capture the measurement target with sufficiently accuracy in the observation accompanied by the movement of the image pickup range.

At least two of the feature portions according to the present invention described above can be combined. Moreover, the various effects described above are mere examples and should not be limited thereto, and other effects may also be exerted.

What is claimed is:

1. An image measurement apparatus, comprising:
an image pickup unit that captures a measurement target;
a mounting unit on which the measurement target is mounted, the mounting unit being capable of moving relative to the image pickup unit; and
a judgment unit that judges, based on information related to a relative position between the image pickup unit and the mounting unit within a predetermined time, whether capturing of a measurement image by the image pickup unit is possible.

2. The image measurement apparatus according to claim 1, wherein
the judgment unit judges that the capturing of the measurement image is possible in a case where a change of the relative position between the image pickup unit and the mounting unit within the predetermined time falls within a predetermined range.

3. The image measurement apparatus according to claim 1, wherein
the mounting unit includes a mounting surface on which the measurement target is to be mounted and is movable relative to the image pickup unit along a first direction and a second direction that are mutually orthogonal and parallel to the mounting surface.

4. The image measurement apparatus according to claim 3, further comprising
a coordinate detection unit capable of detecting a first coordinate value that indicates the relative position between the image pickup unit and the mounting unit along the first direction and a second coordinate value that indicates the relative position between the image pickup unit and the mounting unit along the second direction.

5. The image measurement apparatus according to claim 4, wherein
the judgment unit judges that the capturing of the measurement image is possible in a case where the first coordinate values within the predetermined time fall within a first range and the second coordinate values within the predetermined time fall within a second range.

6. The image measurement apparatus according to claim 5, wherein
each of the first range and the second range is a range that is set while using an image pickup position for capturing the measurement image as a reference.

7. The image measurement apparatus according to claim 6, wherein
the first range and the second range have mutually-equal sizes.

8. The image measurement apparatus according to claim 6, wherein
the judgment unit acquires each of the first coordinate values and the second coordinate values at a predetermined sampling rate and judges that the capturing of the measurement image is possible in a case where all of the first coordinate values in a number corresponding to the predetermined time fall within the first range and all of the second coordinate values in a number corresponding to the predetermined time fall within the second range.

9. The image measurement apparatus according to claim 4, wherein
the judgment unit judges that the capturing of the measurement image is possible in a case where a difference between a maximum value and minimum value of the first coordinate values within the predetermined time is smaller than a first threshold value and a difference between a maximum value and minimum value of the second coordinate values within the predetermined time is smaller than a second threshold value.

10. The image measurement apparatus according to claim 1, wherein
the judgment unit permits the image pickup unit to capture the measurement image in a case where it is judged that the capturing of the measurement image is possible.

11. The image measurement apparatus according to claim 1, wherein
the judgment unit outputs a request signal for requesting the image pickup unit to capture the measurement image in a case where it is judged that the capturing of the measurement image is possible.

12. The image measurement apparatus according to claim 11, further comprising
a switch unit that controls an input of the request signal to the image pickup unit.

13. The image measurement apparatus according to claim 12, wherein
the switch unit includes an operation switch for executing the capturing of the measurement image by the image pickup unit and inputs the request signal output from the judgment unit to the image pickup unit in response to an operation made to the operation switch.

14. The image measurement apparatus according to claim 13, further comprising
an operation mechanism for manually moving the mounting unit,
wherein
the operation switch is arranged in a vicinity of the operation mechanism.

15. The image measurement apparatus according to claim 13, wherein
the operation switch includes a lighting unit that varies a lighting state based on at least one of a distance between a current position as a current relative position between the image pickup unit and the mounting unit and an image pickup position for capturing the measurement image, and a judgment result obtained by the judgment unit.

16. The image measurement apparatus according to claim 1, further comprising
a notification unit that notifies a judgment result obtained by the judgment unit.

17. The image measurement apparatus according to claim 16, wherein
the notification unit notifies a completion of the capturing of the measurement image by the image pickup unit.

18. The image measurement apparatus according to claim 1, wherein
the image pickup unit is capable of capturing an observation image for observing the measurement target.

19. The image measurement apparatus according to claim 18, further comprising:
a display unit capable of displaying the measurement image and the observation image; and
a display control unit that controls image display by the display unit.

20. The image measurement apparatus according to claim 19, wherein
the display control unit generates an auxiliary image that assists the capturing of the measurement image and displays the observation image and the auxiliary image on the display unit.
